(19) United States
(12) Patent Application Publication
(10) Pub. No.: US 2024/0314810 A1
(43) Pub. Date: Sep. 19, 2024

(54) METHOD FOR RESOURCE EXCLUSION, AND DEVICE, AND STORAGE MEDIUM

(71) Applicant: GUANGDONG OPPO MOBILE TELECOMMUNICATIONS CORP., LTD., Dongguan (CN)

(72) Inventor: Yi DING, Dongguan (CN)

(21) Appl. No.: 18/663,001

(22) Filed: May 13, 2024

Related U.S. Application Data
(63) Continuation of application No. PCT/CN2021/142659, filed on Dec. 29, 2021.

(51) Int. Cl. H04W 72/25; H04W 28/26; H04W 72/0446

(52) U.S. Cl. CPC H04W 72/25; H04W 28/26; H04W 72/0446

(57) ABSTRACT

Provided is a method for resource exclusion. The method is applicable to a terminal device. The method includes: determining, based on a first slot where sidelink control information is monitored, Q slots corresponding to the first slot, wherein in the case that a first parameter is configured, Q is equal to 1 or 2 or ┌Tscal/Prx┐ or ┌Tscal/Prx┐+1, wherein the first parameter is defined to indicate an additional periodic sensing occasion, Prx represents a resource reservation period carried in the sidelink control information, and Tscal is determined based on a resource selection window or selected candidate slots; and excluding a first resource in the case that resources determined based on the first slot and the Q slots overlap with the first resource or a periodic resource corresponding to the first resource.

### CROSS-REFERENCE TO RELATED APPLICATION

This application is a continuation of International Application No. PCT/CN2021/142659, filed Dec. 29, 2021, the entire disclosure of which is incorporated herein by reference.

### TECHNICAL FIELD

Embodiments of the present disclosure relate to the technical field of communications, and in particular, relate to a method and an apparatus for resource exclusion, and a device, a storage medium, and a program product.

### BACKGROUND

In sidelink (SL) communication, terminal devices may select transmission resources from a resource pool by sensing.

For saving the power consumption of the terminal devices, a partial sensing mechanism is introduced, which is intended to save energy mainly by limiting a number of time units for resource selection and a number of time units for resource sensing.

### SUMMARY

Embodiments of the present disclosure provide a method and an apparatus for resource exclusion, and a device, a storage medium, and a program product. The technical solutions are as follows.

According to some embodiments of the present disclosure, a method for resource exclusion is provided. The method is applicable to a terminal device. The method includes:

determining, based on a first slot where sidelink control information is monitored, Q slots corresponding to the first slot, wherein in the case that a first parameter is configured, Q is equal to 1 or 2 or ┌Tscal/Prx┐ or ┌Tscal/Prx┐+1, wherein the first parameter is defined to indicate an additional periodic sensing occasion, Prx represents a resource reservation period carried in the sidelink control information, and Tscal is determined based on a resource selection window or selected candidate slots; and

excluding a first resource in the case that resources determined based on the first slot and the Q slots overlap with the first resource or a periodic resource corresponding to the first resource.

According to some embodiments of the present disclosure, an apparatus for resource exclusion is provided. The apparatus includes:
a determining module, configured to determine, based on a first slot where sidelink control information is monitored, Q slots corresponding to the first slot, wherein in the case that a first parameter is configured, Q is equal to 1 or 2 or ┌Tscal/Prx┐ or ┌Tscal/Prx┐+1, wherein the first parameter is defined to indicate an additional periodic sensing occasion, Prx represents a resource reservation period carried in the sidelink control information, and Tscal is determined based on a resource selection window or selected candidate slots; and
an excluding module, configured to exclude a first resource in the case that resources determined based on the first slot and the Q slots overlap with the first resource or a periodic resource corresponding to the first resource.

According to some embodiments of the present disclosure, a terminal device is provided. The terminal device includes a processor and a memory having a computer program stored thereon, wherein the processor, when running the computer program, is caused to perform the method for resource exclusion described above.

According to some embodiments of the present disclosure, a non-transitory computer-readable storage medium having a computer program stored thereon is provided. The computer program, when run by a processor, causes the processor to perform the method for resource exclusion described above.

According to some embodiments of the present disclosure, a chip is provided. The chip includes a programmable logic circuit and/or program instructions, wherein the chip, when running, is configured to perform the method for resource exclusion described above.

According to some embodiments of the present disclosure, a computer program product or computer program is provided. The computer program product or computer program includes computer instructions stored in a computer-readable storage medium, wherein the computer instructions, when read from the computer-readable storage medium and executed by a processor, cause the processor to perform the method for resource exclusion described above.

### BRIEF DESCRIPTION OF THE DRAWINGS

FIG. 1 is a schematic diagram of a network architecture according to some embodiments of the present disclosure;

FIG. 2 is a schematic diagram of a physical layer structure in SL communication according to some embodiments of the present disclosure;

FIG. 3 is a schematic diagram of reservation of time-frequency resource locations according to some embodiments of the present disclosure;

FIG. 4 is a schematic diagram of resource sensing and resource selection according to some embodiments of the present disclosure;

FIG. 5 exemplarily shows a schematic diagram of resource selection in a partial sensing mechanism;

FIG. 6 is a flowchart of a method for resource exclusion according to some embodiments of the present disclosure;

FIG. 7 is a flowchart for determining a Q value according to some embodiments of the present disclosure;

FIG. 8 is a flowchart of a method for resource exclusion according to some embodiments of the present disclosure;

FIG. 9 is a schematic diagram of resource exclusion in a partial sensing mechanism according to some embodiments of the present disclosure;

FIG. 10 is a schematic diagram of resource exclusion in a partial sensing mechanism according to some embodiments of the present disclosure;

FIG. 11 is a block diagram of an apparatus for resource exclusion according to some embodiments of the present disclosure; and

FIG. 12 is a schematic structural diagram of a terminal device according to some embodiments of the present disclosure.

### DETAILED DESCRIPTION

For clearer descriptions of the objects, technical solutions, and advantages of the present disclosure, embodiments of the present disclosure are further described in detail below with reference to the accompanying drawings.

The network architecture and service scenarios described in the embodiments of the present disclosure are intended to describe the technical solutions in the embodiments of the present disclosure more clearly, but do not construe any limitation on the technical solutions according to the embodiments of the present disclosure. Those of ordinary skill in the art learn that, with the evolution of the network architecture and the emergence of new service scenarios, the technical solutions according to the embodiments of the present disclosure are also applicable to similar technical problems.

Referring to FIG. 1, a schematic diagram of a network architecture according to some embodiments of the present disclosure is shown. The network architecture may include: a core network 11, an access network 12, and terminal devices 13.

The core network 11 includes a plurality of core network devices. The core network devices mainly function to provide user connection, user management, and service bearing, and serve as a bearer network to provide an interface to an external network. For example, the core network of a 5th generation (5G) new radio (NR) system may include devices such as an access and mobility management function (AMF) entity, a user plane function (UPF) entity, and a session management function (SMF) entity.

A plurality of access network devices 14 are included in the access network 12. The access network in the 5G NR system may be referred to as a new generation-radio access network (NG-RAN). The access network devices 14 refer to devices deployed in the access network 12 to provide radio communication functionality for the terminal devices 13. The access network devices 14 may include various forms of macro base stations, micro base stations, relay stations, access points, and the like. In systems using different radio access technologies, a device with functionality of an access network device may have different names. For example, the device is referred to as gNodeB or gNB in the 5G NR system. As communications technologies evolve, the name “access network device” may change. For convenience of description, in the embodiments of the present disclosure, the above devices providing the radio communication functionality for the terminal devices 13 are collectively referred to as the access network devices.

Generally, a plurality of terminal devices 13 are present, with one or more terminal devices 13 being distributed in a cell managed by each access network device 14. The terminal devices 13 may include various handheld devices, vehicle-mounted devices, wearable devices, computing devices, or other processing devices connected to a radio modem with the radio communication functionality, as well as various forms of user equipment, mobile stations (MS), and the like. For convenience of description, the devices described above are collectively referred to as the terminal devices. The access network devices 14 and the core network devices communicate with each other over some air technology, such as an NG interface in the 5G NR system. The access network devices 14 and the terminal devices 13 communicate with each other over some air technology, such as a Uu interface.

The terminal devices 13 (for example, the vehicle-mounted device and another device, such as another vehicle-mounted device, a mobile phone, or a road side unit (RSU)) may communicate with each other via a direct communication interface, such as a PC5 interface, and accordingly, the communication link established based on the direct communication interface may be referred to as a direct link or SL. The SL transmission is transmission of communication data between the terminal devices directly over a sidelink, which is different from a conventional cellular system in which the communication data is received or transmitted by access network devices. The SL transmission has characteristics of short delay and low overhead, and is therefore suitable for communication between two terminal devices that are geographically close to each other, such as a vehicle-mounted device and another peripheral device that is geographically close to the vehicle-mounted device. It should be noted that, in FIG. 1, only vehicle-to-vehicle communication in a vehicle-to-everything (V2X) scenario is illustrated, while the SL technology is applicable to various scenarios in which communication is directly performed between terminal devices. In other words, the terminal device in the present disclosure refers to any device that communicates by using the SL technology.

The “5G NR system” in the embodiments of the present disclosure may also be referred to as a 5G system or an NR system, while those skilled in the art can understand the meaning thereof. The technical solutions described in the embodiments of the present disclosure are applicable to the 5G NR system, and also to a subsequent evolved system of the 5G NR system.

Before the technical solutions of the present disclosure are detailed, some background technical knowledge involved in the present disclosure is first explained. Alternatively, the following related technologies may be combined with the technical solutions of the embodiments of the present disclosure in any manner, all of which fall within the protection scope of the embodiments of the present disclosure. The embodiments of the present disclosure include at least some of the following.

For the SL transmission, 3GPP has defined two transmission modes: a mode A and a mode B.

In the mode A, transmission resources for terminal devices are assigned by access network devices (such as base stations), and the terminal devices transmit communication data on sidelinks based on the transmission resources assigned by the access network devices, wherein the access network devices may assign transmission resources to the terminal devices for single transmission, or assign transmission resources to the terminal devices for semi-static transmission.

In the mode B, terminal devices select transmission resources from a resource pool independently for transmission of communication data. Specifically, the terminal devices may select the transmission resources from the resource pool by sensing, or select the transmission resources from the resource pool by random selection.

Next, it is SL communication in the NR V2X system that is mainly described, wherein the terminal devices select resources independently (i.e., the mode B described above).

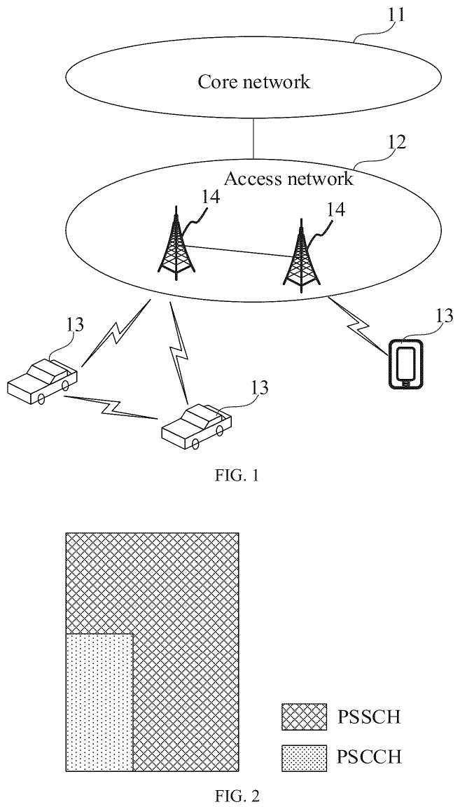

A physical layer structure of the SL communication in the NR V2X system is shown in FIG. 2. A physical sidelink control channel (PSCCH) is configured to bear first sidelink control information, and a physical sidelink shared channel (PSSCH) is configured to bear data and second sidelink control information. The PSCCH and PSSCH are transmitted in the same slot. The first sidelink control information and the second sidelink control information may be two types of sidelink control information of different roles. For example, the first sidelink control information is borne in the PSCCH and mainly includes fields related to resource sensing, which facilitate other terminal devices to exclude and select resources after decoding. In the PSSCH, the second sidelink control information is further borne in addition to the data, wherein the second sidelink control information mainly includes fields related to data demodulation, which facilitate other terminal devices to demodulate the data in the PSSCH.

In the NR V2X system, in the mode B described above, the terminal devices select transmission resources independently for data transmission. Resource reservation is a prerequisite for resource selection.

The resource reservation means that the terminal device transmits the first sidelink control information in the PSCCH to reserve resources to be used next. In the NR V2X system, intra-transport block (TB) resource reservation is supported, and inter-TB resource reservation is supported as well.

As shown in FIG. 3, the terminal device transmits the first sidelink control information, and indicates N time-frequency resources (including a resource used for current transmission) of a current TB by using “time resource assignment” and “frequency resource assignment” fields in the first sidelink control information. N≤Nmax, and Nmax is equal to 2 or 3 in NR V2X. Besides, the indicated N time-frequency resources should be distributed in W slots. W is equal to 32 in NR V2X. For example, in a TB1 as shown in FIG. 3, the terminal device transmits the first sidelink control information in the PSCCH while transmitting initial transmission data in the PSSCH, and indicates time-frequency resource locations for initial transmission and retransmission 1 (i.e., N=2 at this time) by using the two fields described above, i.e., to reserve a time-frequency resource for Retransmission 1. Moreover, initial transmission and retransmission 1 are distributed in 32 slots in a time domain. Similarly, in the TB1 as shown in FIG. 3, the terminal device indicates time-frequency resource locations for retransmission 1 and retransmission 2 by using the first sidelink control information transmitted in the PSCCH of retransmission 1, and retransmission 1 and retransmission 2 are distributed in 32 slots in the time domain.

Besides, when transmitting the first sidelink control information, the terminal device performs the inter-TB resource reservation by using a “resource reservation period” field. For example, in FIG. 3, when transmitting the first sidelink control information of initial transmission of the TB1, the terminal device indicates time-frequency resource locations for initial transmission and retransmission 1 of the TB1 by using the “time resource assignment” and “frequency resource assignment” fields, which are denoted as {(t₁, f₁),(t₂, f₂)}, wherein t₁ and t₂ represent time domain locations of initial transmission and retransmission 1 resources of the TB1, and f₁ and f₂ represent corresponding frequency domain locations. In the case that a value of the “resource reservation period” field in the first sidelink control information is 100 ms, the sidelink control information (SCI) indicates time-frequency resources {(t₁30 100, f₁), (t₂+100, f₂)} at the same time, which are defined for transmission of initial transmission and retransmission 1 of a TB2. Similarly, when transmitting the first sidelink control information in retransmission 1 of the TB1, the terminal also reserves time-frequency resources for retransmission 1 and retransmission 2 of the TB2 by using the “resource reservation period” field. In NR V2X, the value of the “resource reservation period” field is possibly 0, 1-99, 100, 200, 300, 400, 500, 600, 700, 800, 900, or 1000 ms, which is more flexible than long-term evolution (LTE) V2X. However, only e values are configured in each resource pool, and the terminal device determines a possible value to be used based on the used resource pool. The e values in the resource pool configuration are denoted as a resource reservation period set M, and exemplarily, e is less than or equal to 16.

In addition, by network configuration or preconfiguration, the above inter-TB reservation may be activated or deactivated on a resource pool basis. In the case that the inter-TB reservation is activated, the first sidelink control information includes the “resource reservation period” field. In the case that the inter-TB reservation is deactivated, the first sidelink control information does not include the “resource reservation period” field. In the case that the inter-TB reservation is activated, the value of the “resource reservation period” field used by the terminal device, i.e., the resource reservation period, is generally not changed before resource reselection is triggered. The terminal device reserves resources for a next period by using the “resource reservation period” field in the first sidelink control information for transmission of another TB each time the terminal device transmits the first sidelink control information, thereby enabling periodic semi-contiguous transmission.

In the case that the terminal device operates in the mode B described above, the terminal device may acquire the first sidelink control information transmitted by other terminal devices by sensing the PSCCHs from the other terminal devices, such that the resources reserved by the other terminal devices are acknowledged. When performing resource selection, the terminal device may exclude the resources reserved by the other terminal devices, such that resource collision is avoided.

In the NR V2X system, in the mode B described above, the terminal device needs to select resources independently.

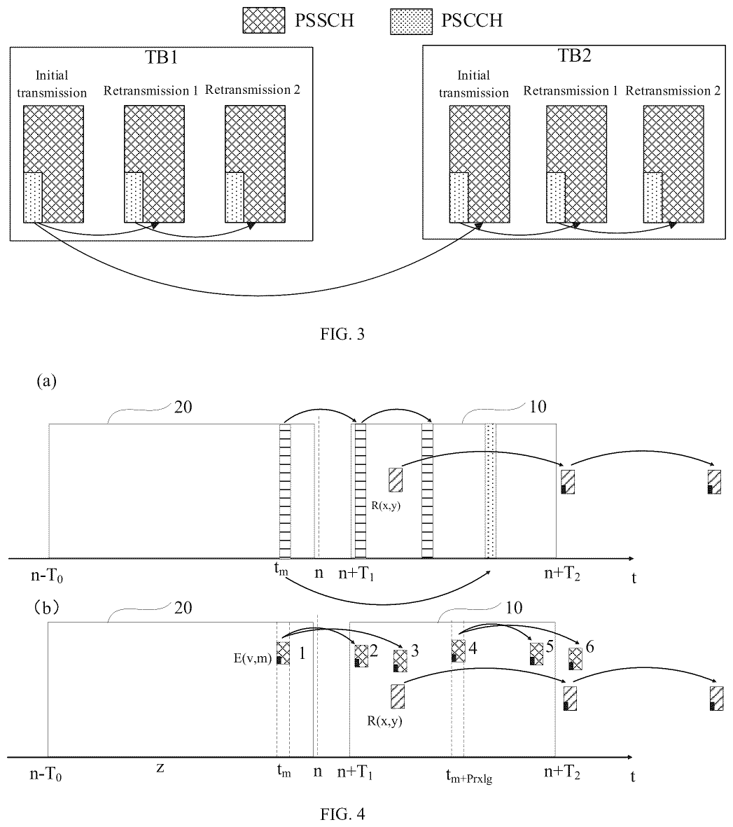

As shown in FIG. 4, the terminal device triggers resource selection or reselection in a slot n, or the slot n is a slot where a higher layer triggers a physical layer to report a candidate resource set, and a resource selection window 10 starts from n+T₁ and ends at n+T₂. 0≤T₁≤T_{proc,1}, and in the case that a subcarrier interval is 15, 30, 60, or 120 kHz, t_{proc,1} is 3, 5, 9, or 17 slots. T₂ₘᵢₙ≤T₂≤a remaining delay estimate of service, wherein a value set of T₂ₘᵢₙ is {1, 5, 10, 20}*2^{μ} slots, wherein μ=0, 1, 2, and 3, which correspond to the subcarrier interval being 15, 30, 60, and 120 kHz, respectively. The terminal device determines T₂ₘᵢₙ from the value set based on a priority of its own to-be-transmitted data. For example, in the case that the subcarrier interval is 15 kHz, the terminal device determines T₂ₘᵢₙ from the set {1, 5, 10, 20} based on the priority of its own to-be-transmitted data. In the case that T₂ₘᵢₙ is greater than or equal to the remaining delay estimate of service, T₂ is equal to the remaining delay estimate of service. The remaining delay estimate means a difference between a corresponding time of a delay requirement of the data and a current time. For example, for a packet arriving at the slot n, the delay requirement is 50 ms, and assuming that one slot is 1 ms, then the remaining delay estimate is 50 ms in the case that the current time is the slot n, and the remaining delay estimate is 30 ms in the case that the current time is a slot n+20.

The terminal device senses resources from n-T₀ to n-T_{proc,0} (excluding n-T_{proc,0}), and a value of T₀ is 100 or 1100 ms. In the case that the subcarrier interval is 15, 30, 60, or 120 kHz, T_{proc,0} is 1, 1, 2, or 4 slots. In some embodiments, the terminal device senses resources in a slot that is within a resource pool used by the terminal device within a resource sensing window. In some embodiments, the terminal device monitors the first sidelink control information transmitted by other terminal devices in each slot (except for its own transmission slot), and where resource selection or reselection is triggered in the slot n, the terminal device uses the results from resource sensing from n-T₀ to n-T_{proc,0}.

In step 1, the terminal device regards all available resources that are within the resource pool used by the terminal device in the resource selection window 10 as a resource set A, and any of the resources in the set A is denoted as R(x, y), wherein x and y respectively indicate a frequency domain location and a time domain location of the resource. An initial number of the resources in the set A is denoted as Mₜₒₜₐₗ. The terminal device performs exclusion on the resources in the resource set A based on a non-sensing occasion in the resource sensing window 20 (step 1-1) and/or resource sensing results in the resource sensing window 20 (step 1-2). The terminal device determines whether the resource R(x, y) or a series of periodic resources corresponding to the resource R(x, y) overlaps with a slot determined based on the non-sensing occasion in step 1-1 or a resource determined based on the monitored first sidelink control information in step 1-2, and excludes the resource R(x, y) from the resource set A in the case that they overlap.

In step 1-1, in the case that the terminal device transmits data in the slot tₘ in the resource sensing window 20 and does not perform sensing, the terminal device determines corresponding Q slots based on the slot tₘ and each allowed resource reservation period in the resource pool used by the terminal device, with the resource reservation period as an interval. In the case that the Q slots overlap with the resource R(x, y) or the series of periodic resources corresponding to the resource R(x, y), the resource R(x, y) is excluded from the resource set A. The above Q=1 or Q=┌Tscal/Prx┐ (for rounding up). Tscal is equal to a converted value of T₂ into milliseconds. Prx is one of the resource reservation periods allowed by the resource pool used by the terminal device. In some embodiments, the series of periodic resources corresponding to the resource R(x, y) are R(x, y+j*Ptxlg), wherein j=0, 1, 2, . . . , Cresel-1. Cresel is associated with a random count value generated by the terminal device, and Ptxlg is a number of logical slots converted from Prx. Ptx is the resource reservation period of the terminal device. For example, in FIG. 4(a), Cresel is equal to 3, representing 3 periodic resources (including R(x, y)) corresponding to the resource R(x, y). In some embodiments, in the case that Prx<Tscal and/or n1−m is less than or equal to Prxlg, Q=┌Tscal/Prx┐. Prxlg represents the number of the logical slots converted from Prx. In some embodiments, Q=1. In the case that the slot n is within the resource pool used by the terminal device, tₙ₁ is n, or otherwise, tₙ₁ is a first slot within the resource pool used by the terminal device after n. In some embodiments, the Q slots are t_{m+q*Prxlg}, wherein q is 1, 2, . . . , Q.

In some embodiments, the slots in the resource pool of the terminal device are (t₁, t₂, . . . , t_{N}). That is, tₘ, tₙ₁, and t_{m+q*Prxlg}, are slots within the resource pool, and the slots corresponding to R(x, y+j*Ptxlg) are also those within the resource pool.

For example, in subfigure (a) of FIG. 4, the terminal device does not perform sensing in the slot tₘ, and performs resource exclusion in sequence based on each resource reservation period in the resource reservation period set M in the used resource pool configuration. For a resource reservation period 1, assuming that the Q value is calculated to be 2, then the corresponding Q slots are two next slots mapped from the slot tₘ in FIG. 4(a) as indicated by cross hatching, with the resource reservation period 1 as an interval. For a resource reservation period 2, assuming that the Q value is calculated to be Q=1, then the corresponding Q slots are one next slot mapped from the slot tₘ in FIG. 4(a) as indicated by dot hatching, with the resource reservation period 2 as an interval.

The terminal device determines whether Q slots corresponding to each reservation period overlap with the resource R(x, y) or the series of periodic resources corresponding to the resource R(x, y), and excludes the resource R(x, y) from the resource set A in the case that they overlap.

In some embodiments, in the case that the inter-TB reservation is deactivated in the resource pool used by the terminal device, the terminal device does not perform step 1-1 above.

In some embodiments, where step 1-1 is performed, in the case that the remaining resources in the resource set A are less than Mₜₒₜₐₗ*X, the resource set A is initialized into all available resources within the resource pool used by the terminal device in the resource selection window 10, and then step 1-2 is performed.

In step 1-2, in the case that the terminal device monitors the first sidelink control information transmitted in the PSCCH within the slot t of the resource sensing window 20, a sidelink reference signal received power (SL-RSRP) of the PSCCH or an SL-RSRP of the PSSCH scheduled by the PSCCH (i.e., the SL-RSRP of the PSCCH transmitted in the same slot as the PSCCH) is measured.

In the case that the measured SL-RSRP is greater than an SL-RSRP threshold and the inter-TB resource reservation is activated in the resource pool used by the terminal device, the terminal device determines the Q corresponding slots based on the slot tₘ and the resource reservation period carried in the monitored first sidelink control information, with the resource reservation period as an interval. The terminal device assumes that the first sidelink control information with the same content is received in the Q slots as well. The terminal device determines whether the resources indicated by the “time resource assignment” and “frequency resource assignment” fields of the first sidelink control information received at the slot tₘ and the Q pieces of first sidelink control information assumed to be received overlap with the resource R(x, y) or the series of periodic resources corresponding to the resource R(x, y), and excludes the corresponding resource R(x, y) from the set A in the case that they overlap. The above Q=1 or Q=┌Tscal/Prx┐ (for rounding up). Tscal is equal to a converted value of T₂ into milliseconds. Prx is the resource reservation period carried in the monitored first sidelink control information. In some embodiments, the series of periodic resources corresponding to the resource R(x, y) are R(x, y+j*Ptxlg), wherein j=0, 1, 2, . . . Cresel-1. Cresel is associated with a random count value generated by the terminal device, and Ptxlg is a number of logical slots converted from Prx. Ptx is the resource reservation period of the terminal device. For example, in subfigure (a) of FIG. 4, Cresel is equal to 3, representing three periodic resources (including R(x, y)) corresponding to the resource R(x, y). In some embodiments, in the case that Prx<Tscal and/or n1−m is less than or equal to Prxlg, Q=┌Tscal/Prx┐. Prxlg represents the number of the logical slots converted from Prx. In the case that the slot n is within the resource pool used by the terminal device, tₙ₁ is n, or otherwise, tₙ₁ is a first slot within the resource pool used by the terminal device after n. In some embodiments, the Q slots are t_{m+q*Prxlg}, wherein q is 1, 2, . . . , Q.

In some embodiments, the slots in the resource pool of the terminal device are (t₁, t₂, . . . , t_{N}). That is, tₘ, tₙ₁, and t_{m+q*Prxlg} are slots within the resource pool, and the slots corresponding to R(x, y+j*Ptxlg) are also those within the resource pool.

For example, in subfigure (a) of FIG. 4 where the inter-TB reservation is activated in the resource pool used by the terminal device, in the case that the terminal device monitors the first sidelink control information in the PSCCH on a resource E(v, m) at the slot tₘ, the resource reservation period in the first sidelink control information is Prx, and assuming that the Q value is calculated to be 1, then the terminal device assumes that the first sidelink control information with the same content is received at the slot t_{m+Prxlg} as well. The terminal device determines whether the resources 1, 2, 3, 4, 5, and 6 indicated by the “time resource assignment” and “frequency resource assignment” fields of the first sidelink control information received at the slot tₘ and the first sidelink control information assumed to be received at the slot t_{m+Prxlg} overlap with the resource R(x, y) or the series of periodic resources corresponding to the resource R(x, y), and excludes the resource R(x, y) from the resource set A in the case that the resource overlap with each other and the RSRP condition is satisfied.

In the case that the SL-RSRP measured by the terminal device is greater than the SL-RSRP threshold and the inter-TB resource reservation is deactivated in the resource pool used by the terminal device, the terminal device only determines whether the resources indicated by the “time resource assignment” and “frequency resource assignment” fields of the first sidelink control information received at the slot tₘ overlap with the resource R(x, y) or the series of resources corresponding to the resource R(x, y), and excludes the resource R(x, y) from the resource set A in the case that they overlap.

For example, in subfigure (b) of FIG. 4 where the inter-TB reservation is deactivated in the resource pool used by the terminal device, in the case that the terminal device monitors the first sidelink control information in the PSCCH on the resource E(v, m) at the slot tₘ, the terminal device determines whether the resources 1, 2, and 3 indicated by the “time resource assignment” and “frequency resource assignment” fields in the first sidelink control information overlap with the resource R(x, y) or the series of periodic resources corresponding to the resource R(x, y), and excludes the resource R(x, y) from the resource set A in the case that the resources overlap with each other and the RSRP condition is satisfied.

In the case that the remaining resources in the resource set A after resource exclusion are less than Mₜₒₜₐₗ*X, the SL-RSRP threshold is raised by 3 dB, and step 1 is performed again. The physical layer reports the resource set A after resource exclusion to a higher layer as a candidate resource set.

In step 2, the higher layer randomly selects resources from the reported candidate resource set for data transmission. That is, the terminal device randomly selects resources from the candidate resource set for data transmission.

It should be noted that:
1. The RSRP threshold is determined based on the priority P1 carried in the PSCCH sensed by the terminal device and the priority P2 of the data to be transmitted by the terminal device. The configuration of the resource pool used by the terminal device includes an SL-RSRP threshold table, and the SL-RSRP threshold table includes SL-RSRP thresholds corresponding to all priority combinations. The configuration of the resource pool may be configured by a network or preconfigured.

For example, as shown in Table 1, assuming that the selectable values of the priority levels of both P1 and P2 are 0 to 7, then the SL-RSRP thresholds corresponding to different priority combinations are represented by γᵢⱼ, wherein in γᵢⱼ, i represents a value of the priority level P1, and j represents a value of the priority level P2.

TABLE 1
SL-RSRP threshold

P2

| P1 | 0 | 1 | 2 | 3 | 4 | 5 | 6 | 7 |
|---|---|---|---|---|---|---|---|---|
| 0 | γ₀₀ | γ₀₁ | γ₀₂ | γ₀₃ | γ₀₄ | γ₀₅ | γ₀₆ | γ₀₇ |
| 1 | γ₁₀ | γ₁₁ | γ₁₂ | γ₁₃ | γ₁₄ | γ₁₅ | γ₁₆ | γ₁₇ |
| 2 | γ₂₀ | γ₂₁ | γ₂₂ | γ₂₃ | γ₂₄ | γ₂₅ | γ₂₆ | γ₂₇ |
| 3 | γ₃₀ | γ₃₁ | γ₃₂ | γ₃₃ | γ₃₄ | γ₃₅ | γ₃₆ | γ₃₇ |
| 4 | γ₄₀ | γ₄₁ | γ₄₂ | γ₄₃ | γ₄₄ | γ₄₅ | γ₄₆ | γ₄₇ |
| 5 | γ₅₀ | γ₅₁ | γ₅₂ | γ₅₃ | γ₅₄ | γ₅₅ | γ₅₆ | γ₅₇ |
| 6 | γ₆₀ | γ₆₁ | γ₆₂ | γ₆₃ | γ₆₄ | γ₆₅ | γ₆₆ | γ₆₇ |
| 7 | γ₇₀ | γ₇₁ | γ₇₂ | γ₇₃ | γ₇₄ | γ₇₅ | γ₇₆ | γ₇₇ |

In the case that the terminal device senses the PSCCH transmitted by another terminal device, the priority P1 carried in the first sidelink control information transmitted in the PSCCH and the priority P2 of the to-be-transmitted data are acquired, and the SL-RSRP threshold is determined by the terminal device by looking up Table 1.
2. Whether the terminal device compares the measured PSCCH-RSRP or a PSSCH-RSRP scheduled by the PSCCH with the SL-RSRP threshold depends on the resource pool configuration of the resource pool used by the terminal device. The configuration of the resource pool may be configured by a network or preconfigured.
3. The value of X described above is possibly {20%, 35%, 50%}. The configuration of the resource pool used by the terminal device includes correspondence between the priorities and the possible values described above, and the terminal device determines the value of X based on the priority of the to-be-transmitted data and the correspondence. The resource pool configuration may be configured by the network or preconfigured.
4. The resource reservation period is converted into logical slots.

As mentioned above, the terminal device transmits the first sidelink control information to indicate time-frequency resources to reserve resources to be used next. In sensing, the terminal device for resource selection decodes the first sidelink control information transmitted by other terminal devices to acquire resources reserved by the other terminal devices, and then excludes the corresponding resources during resource selection, such that resource collision is avoided. In resource exclusion, the terminal device for resource selection converts a physical time (for example, 100 ms) indicated by the “resource reservation period” field in the decoded first sidelink control information into a corresponding number of logical slots, and then performs resource exclusion by using the number of the logical slots:

$$\\ {P}_{rsvp}^{{}_{} ′} = ⌈ \frac{{T}_{max}^{{}_{} ′}}{10240 ms} \times {P}_{rsvp} ⌉$$

In the above formula, Prsvp represents a resource reservation period, for example, a resource reservation period indicated by the “resource reservation period” in the first sidelink control information monitored by the terminal device, or a resource reservation period allowed in the resource pool, or a resource reservation period of the terminal device, and P′rsvp represents a calculated number of corresponding logical slots. T′max represents a number of slots within a resource pool or a transmission resource pool of the terminal device in a system frame number (SFN) period or in 10240 ms.

The above description is for the SL communication method in NR-V2X, i.e., the terminal device independently selects transmission resources by resource sensing and performs data transmission on the sidelink independently. The SL communication method is applicable to various SL communications such as direct communication between handheld terminals and direct communication between pedestrians and vehicles.

The above method where the terminal device independently selects transmission resources by resource sensing does not consider energy saving. A resource selection method by partial sensing is an energy-saving resource selection method designed for a power-consumption-sensitive terminal such as a handheld terminal, which is intended to save energy mainly by limiting a number of time units for resource selection and a number of time units for resource sensing.

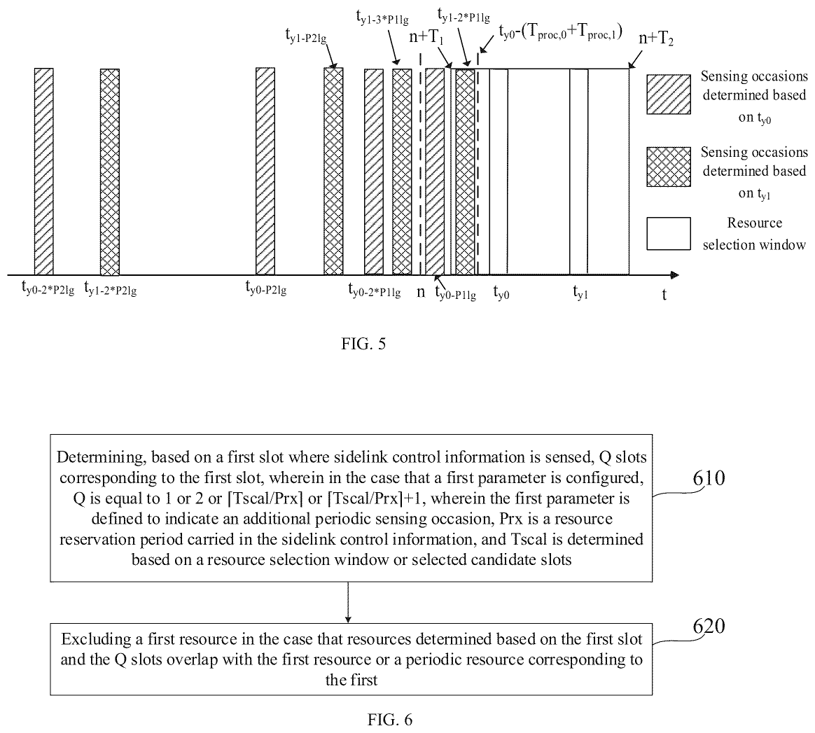

A resource selection algorithm by partial sensing is described next in connection with FIG. 5. The terminal device determines a corresponding sensing occasion based on at least Y slots determined in the resource selection window and the resource reservation period set M or a subset of the resource reservation period set M in the resource pool configuration. Specifically, for any slot t_{y} in the at least Y slots, the sensing occasion determined by the terminal device is t_{y-k*Preserve}, wherein t₁, t₂, . . . , t_{y} denote slots within the resource pool. In the case that the higher layer configures a parameter periodicSensingOccasionReservePeriodList, Preserve corresponds to the resource reservation period included in periodicSensingOccasionReservePeriodList, or otherwise, Preserve corresponds to all resource reservation periods allowed in the resource pool. Alternatively, in the case that the higher layer configures the parameter periodicSensingOccasionReservePeriodList, Preserve corresponds to a value of logical slots converted from the resource reservation period included in periodicSensingOccasionReservePeriodList, or otherwise, Preserve corresponds to values of logical slots converted from all resource reservation periods allowed in the resource pool.

For one of the values corresponding to Preserve, in the case that additionalPeriodicSensingOccasion is not configured, k represents a value corresponding to a latest sensing occasion (denoted as a sensing occasion U) prior to a slot t_{y0}−(T_{proc,0}+T_{proc,1}), or k represents a minimum value (denoted as a value R) that allows t_{y-k*Preserve} to be prior to t_{y0}−(T_{proc,0}+T_{proc,1}). In the case that additionalPeriodicSensingOccasion is configured, k further includes a value corresponding to a last periodic sensing occasion prior to the sensing occasion U, or further includes a value R+1. T_{y0} represents a first slot in the at least Y slots that are determined, or a slot with a foremost time domain location.

Therefore, for each slot t_{y} in the at least Y slots that are determined, the terminal device determines a corresponding k value based on each of the values corresponding to Preserve, thereby determining the sensing occasion t_{y-k*Preserve} corresponding to the t_{y}. The terminal device should perform sensing in the determined sensing occasion.

In some embodiments, the terminal device performs contiguous sensing in ┌n+T_{A}, n+T_{B}┐, wherein n+T_{A} is equal to an M^{th} logical slot prior to t_{y0} (exemplarily, n+T_{A} is equal to t_{y0-M}), and n+T_{B} is a (T_{proc,0}+T_{proc,1})^{th} slot prior to t_{y0} (exemplarily, n+T_{B}=t_{y0}−(T_{proc,0}+T_{proc,1}) or t_{y0}−(T_{proc,0}+T_{proc,1})−1). M is equal to 31 or is configured by the network or preconfigured or is implemented by the terminal device.

For example, in FIG. 5, assuming that the allowed resource periods in the resource pool are P1, P2, and P3, and that periodicSensingOccasionReservePeriodList is configured in the resource pool configuration to include P1 and P2, then Preserve corresponds to values P1lg and P2lg of logical slots converted from P1 and P2. Moreover, it is assumed that the parameter additionalPeriodicSensingOccasion is configured in the resource pool configuration. The slot n is the slot where the higher layer triggers the physical layer to report the candidate resource set, the resource selection window is from n+T₁ to n+T₂, and the terminal device determines two slots, including t_{y0} and t_{y1}, in the resource selection window. For t_{y0}, the determined sensing occasion is t_{y0-k*Preserve}. In the case that Preserve is equal to P1lg, k=1 and 2 as t_{y0-P1lg} is prior to t_{y0}−(T_{proc,0}+T_{proc,1}), and the determined sensing occasions are t_{y0-P1lg} and t_{y0-2*P1lg}. In the case that Preserve is equal to P2lg, k=1 and 2 as t_{y0-P2lg} is prior to t_{y0}−(T_{proc,0}+T_{proc,1}), and the determined sensing occasions are t_{y0-P2lg} and t_{y0-2*P2lg}. For t_{y1}, the determined sensing occasion is t_{y1-k*Preserve}. In the case that Preserve is equal to P1lg, k=2 and 3 as t_{y1-P1lg} is after t_{y0}−(T_{proc,0}+T_{proc,1}) and t_{y1-2*P1lg} is prior to t_{y0}−(T_{proc,0}+T_{proc,1}), and the determined sensing occasions are t_{y1-2*P1lg} and t_{y1-3*P1lg}. In the case that Preserve is equal to P21g, k=1 and 2 as t_{y1-P2lg} is prior to t_{y0}−(T_{proc,0}+T_{proc,1}), and the determined sensing occasions are t_{y1-P2lg} and t_{y1-2*P2lg}. In some embodiments, n+T_{A} is t_{y0-M}, n+T_{B} is t_{y0}−(T_{proc,0}+T_{proc,1}), and the terminal device performs contiguous sensing from n+T_{A} to n+T_{B}. The terminal device performs, based on a sensing result in the above sensing occasion and a sensing result in the above period for contiguous sensing, resource exclusion on the resources in the at least Y slots that are determined, and selects resources from the remaining resources for data transmission.

At present, for the resource selection algorithm by partial sensing, the resource exclusion generally follows the resource exclusion procedure in V2X (such as step 1 as described above), but the related standard details have not been discussed, such as how to calculate the Q value described above.

As can be seen from the example shown in FIG. 5, the current standard supports configuring the parameter additionalPeriodicSensingOccasion to enable the terminal device to perform resource exclusion based on the latest two periodic sensing occasions, for example, to perform exclusion on the resources in t_{y0} based on a sensing result in t_{y0-2*P2lg} as shown in FIG. 5. However, as can be further seen from the above, in the procedure of step 1, Q is mostly equal to 1. This results in that even in the case that exclusion on the resources in t_{y0} based on the sensing result in t_{y0-2*P2lg} is configured, the terminal device cannot exclude resources in t_{y0} at all when performing resource exclusion based on the sidelink control information monitored in t_{y0-2*P2lg} For example, in FIG. 5, the terminal device monitors the sidelink control information with the resource reservation period of P2 in t_{y0-2*P2lg} calculates Q to be 1, and determines the Q corresponding slots to be t_{y0-P2lg}. The terminal device cannot exclude the resources in the slot t_{y0} at all based on the resources indicated by the “time resource assignment” and “frequency resource assignment” fields in the sidelink control information received at t_{y0-2*P2lg} and assumed to be received at t_{y0-P2lg}.

Therefore, the present disclosure discusses the calculation of the Q value in the case that the parameter additionalPeriodicSensingOccasion is configured and in the case that the parameter additionalPeriodicSensingOccasion is not configured, separately.

Referring to FIG. 6, a flowchart of a method for resource exclusion according to some embodiments of the present disclosure is shown. The method is applicable to the network architecture as shown in FIG. 1. For example, the method may be performed by the terminal device. The method includes at least one of the following steps (610-620).

In step 610, Q slots corresponding to a first slot where sidelink control information is monitored are determined based on the first slot, wherein in the case that a first parameter is configured, Q is equal to 1 or 2 or ┌Tscal/Prx┐ or ┌Tscal/Prx┐+1, wherein the first parameter is defined to indicate an additional periodic sensing occasion, Prx represents a resource reservation period carried in the sidelink control information, and Tscal is determined based on a resource selection window or selected candidate slots.

In the embodiments of the present disclosure, the first parameter is defined to indicate the additional periodic sensing occasion. Alternatively, the first parameter is defined to configure or determine the additional periodic sensing occasion. Exemplarily, the first parameter is the parameter additionalPeriodicSensingOccasion as described above.

In the embodiments of the present disclosure, in the case that the first parameter is configured, Q may be equal to 2 or ┌Tscal/Prx┐+1 in addition to 1 or ┌Tscal/Prx┐, addressing the problem that resource exclusion fails to be correctly performed based on an additional sensing occasion even in the case that the additional sensing occasion is configured, enabling the terminal device to correctly perform resource exclusion, such that the communication reliability is improved.

In the embodiments of the present disclosure, it is assumed that m represents the first slot, Prxlg represents a number of logical slots converted from Prx, and that n1 represents a reference slot. For example, m is a slot index of the first slot in the resource pool, and n1 is a slot index of the reference slot in the resource pool. Assuming that (t₁, t₂, . . . , t_{N}) denote slots within the resource pool, and that the first slot and the reference slot are located within the resource pool, then tₘ represents the first slot, and tₙ₁ is the reference slot. In addition, for details about an algorithm for converting the resource reservation period into the logical slots, reference is made to the description above, which are not described herein any further.

In some embodiments, in the case that the first parameter is configured, the value of Q includes at least one of the following cases 1 to 5.

In case 1, in the case that m+Prxlg is less than n1, m+2*Prxlg is greater than or equal to n1, and Prx is less than Tscal, Q=┌Tscal/Prx┐+1. Exemplarily, in the case that m+Prxlg<n1, m+2*Prxlg>n1, and Prx<Tscal, Q=┌Tscal/Prx┐+1. That is, in the case that n1−m>Prxlg, n1−m≤2*Prxlg, and Prx<Tscal, Q=┌Tscal/Prx┐+1.

In case 2, in the case that m+Prxlg is less than n1, m+2*Prxlg is greater than or equal to n1, and Prx is greater than or equal to Tscal, Q=2. Exemplarily, in the case that m+Prxlg<n1, m+2*Prxlg≥n1, and Prx≥Tscal, Q=2. That is, in the case that n1−m>Prxlg, n1−m≤2*Prxlg, and Prx≥Tscal, Q=2.

In case 3, in the case that m+Prxlg is greater than or equal to n1 and Prx is less than Tscal, Q=┌Tscal/Prx┐. Exemplarily, in the case that m+Prxlg>n1 and Prx<Tscal, Q=┌Tscal/Prx┐. That is, in the case that n1−m<Prxlg and Prx<Tscal, Q=┌Tscal/Prx┐.

In case 4, in the case that m+Prxlg is greater than or equal to n1 and Prx is greater than or equal to Tscal, Q=1. Exemplarily, in the case that m+Prxlg≥n1 and Prx≥Tscal, Q=1. That is, in the case that n1−m≤Prxlg and Prx≥Tscal, Q=1.

In case 5, in the case that m+Prxlg is less than n1 and m+2*Prxlg is less than n1, Q=1 or 2. Exemplarily, in the case that m+Prxlg<n1 and m+2*Prxlg<n1, Q=1 or 2. That is, in the case that n1−m>Prxlg and n1−m>2*Prxlg, Q=1 or 2. It should be noted that, for case 5, the condition “m+Prxlg is less than n1” may be omitted. That is, in the case that m+2*Prxlg is less than n1, Q=1 or 2. As in the case that m+2*Prxlg is less than n1, m+Prxlg is inevitably less than n1.

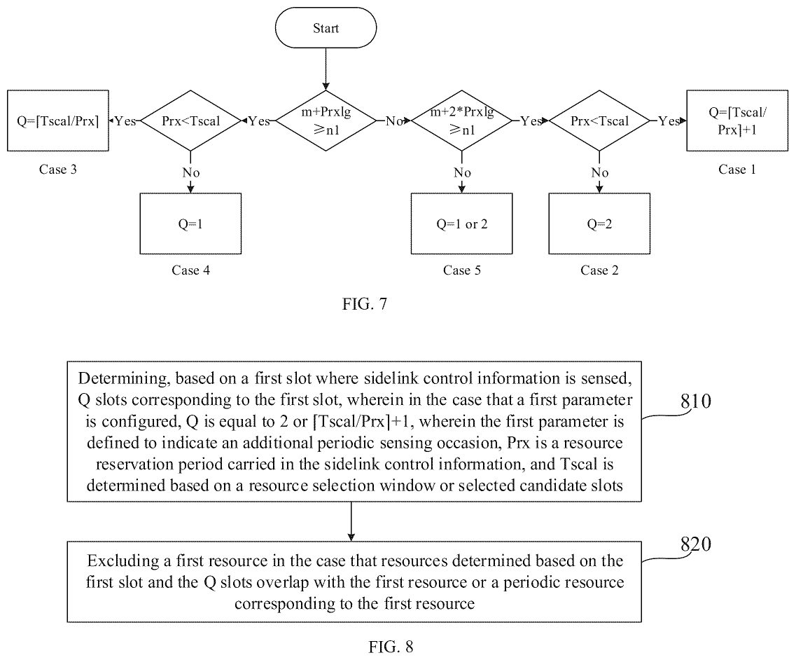

In exemplary embodiments, as shown in FIG. 7, a flowchart for determining a value of Q is exemplarily shown. For example, the procedure is as follows.

In S1, whether m+Prxlg is greater than or equal to n1 is determined; in the case that m+Prxlg is not greater than or equal to n1, step S2 is performed; and in the case that m+Prxlg is greater than or equal to n1, step S4 is performed.

In S2, whether m+2*Prxlg is greater than or equal to n1 is determined; in the case that m+2*Prxlg is greater than or equal to n1, step S3 is performed; and in the case that m+2*Prxlg is not greater than or equal to n1, it is determined that Q=1 or 2 (corresponding to case 5 above).

In S3, whether Prx is less than Tscal is determined; in the case that Prx is less than Tscal, Q=┌Tscal/Prx┐+1 (corresponding to case 1 above); and in the case that Prx is not less than Tscal, Q=2 (corresponding to case 2).

In S4, whether Prx is less than Tscal is determined; in the case that Prx is less than Tscal, Q=┌Tscal/Prx┐ (corresponding to case 3); and in the case that Prx is not less than Tscal, Q=1 (corresponding to case 4 above).

It should be noted that FIG. 7 exemplarily shows only one possible determination procedure for determining the Q value, and the present disclosure is not limiting and the Q value may be further determined based on other determination procedures, for example, determining whether m+2*Prxlg is greater than or equal to n1 first, or determining whether Prx is less than Tscal first, which is not limited herein. In addition, in the example shown in FIG. 7, a total of five determination results of cases 1 to 5 are included, and in further possible embodiments, only any one or more of cases 1 to 5 may be included, which is not limited herein.

In some embodiments, without configuring the first parameter, in the case that m+Prxlg is greater than or equal to n1 and Prx is less than Tscal, Q=┌Tscal/Prx┐; or otherwise, Q=1. Exemplarily, in the case that m+Prxlg≥n1 and Prx<Tscal, Q=┌Tscal/Prx┐; or otherwise, Q=1. That is, in the case that n1−m<Prxlg and Prx<Tscal, Q=┌Tscal/Prx┐; or otherwise, Q=1.

In some embodiments, the reference slot is determined by a first time unit. The first time unit is within a first time domain interval, or the first time unit is a slot where a higher layer triggers a physical layer to report a resource set. A starting position of the first time domain interval includes a last sensing occasion in a time domain determined by the terminal device, and an ending position of the first time domain interval includes a first selected candidate slot in the time domain determined by the terminal device. It should be noted that the last sensing occasion in the time domain refers to a sensing occasion with a rearmost time domain location among the plurality of sensing occasions distributed in the time domain. In the case that the indexes of the sensing occasions are gradually increased in sequence of time domain locations from front to rear, the last sensing occasion in the time domain is a sensing occasion with the largest index. Similarly, the first selected candidate slot in the time domain refers to a selected candidate slot with a foremost time domain location among the plurality of selected candidate slots distributed in the time domain. In the case that the indexes of the selected candidate slots are gradually increased in sequence of time domain locations from front to rear, the first selected candidate slot in the time domain is a selected candidate slot with the smallest index. For similar descriptions that occur elsewhere in the present disclosure, reference is made to the description herein, which will not be described any further.

In some embodiments, in the case that the first time unit is within a resource pool, the reference slot is the first time unit; or in the case that the first time unit is not within the resource pool, the reference slot is a first slot within the resource pool after the first time unit.

In some embodiments, the above resource pool is a resource pool of the terminal device, or a transmission resource pool of the terminal device, or a resource pool used by the terminal device.

For example, (t₁, t₂, . . . , t_{N}) denote slots within the resource pool. n1 is determined by a first time unit. In the case that the first time unit is within the resource pool, tₙ₁ represents the first time unit. In the case that the first time unit is not within the resource pool, tₙ₁ represents the first slot within the resource pool after the first time unit.

In some embodiments, in the case that the first time unit is within the first time domain interval, the first time unit is: the last sensing occasion in the time domain determined by the terminal device, or the last sensing occasion in the time domain determined by the terminal device plus a first offset, or the first selected candidate slot in the time domain determined by the terminal device, or the first selected candidate slot in the time domain determined by the terminal device minus a second offset.

In some embodiments, the first offset is configured by a network, or preconfigured, or dependent on implementation of the terminal device, or a predefined value specified in a standard. Exemplarily, the first offset is one slot, or T_{proc,0}, or T_{proc,0}+T_{proc,1}.

In some embodiments, the second offset is configured by the network, or preconfigured, or dependent on implementation of the terminal device, or a predefined value specified in a standard. Exemplarily, the first offset is one slot, or T_{proc,0}, or T_{proc,0}+T_{proc,1}.

In some embodiments, the Tscal is a converted value of a difference between an ending slot of the resource selection window and the first time unit into milliseconds, or a converted value of a difference between a last selected candidate slot determined by the terminal device and the first time unit into milliseconds.

In some embodiments, the terminal device monitors the sidelink control information at the slot tm, which is exemplarily the first sidelink control information. For description of the first sidelink control information, reference is made to the foregoing, which is not described herein any further.

In some embodiments, the Q slots corresponding to the first slot are t_{m+q*Prxlg}, wherein Q=1, 2, . . . , Q.

In step 620, in the case that resources determined based on the first slot and the Q slots overlap with a first resource or a periodic resource corresponding to the first resource, the first resource is excluded.

In some embodiments, the first resource is denoted as R(x, y), wherein x and y respectively indicate a frequency domain location and a time domain location of the first resource.

In some embodiments, the first resource is any of resources in a candidate resource set. Excluding the first resource includes excluding the first resource from the candidate resource set. The candidate resource set is an initialized resource set and includes all candidate resources in selected candidate slots determined by the terminal device; or the candidate resource set is a resource set formed by remaining resources in the initialized resource set after resource exclusion.

In some embodiments, the selected candidate slots are part of slots determined within the resource selection window by the terminal device. Exemplarily, the selected candidate slots are Y or Y′ candidate slots determined within the resource selection window by the terminal device. The Y candidate slots are slots determined for periodic-based partial sensing, and the Y′ candidate slots are slots determined for contiguous partial sensing.

It should be noted that, in the present disclosure, the selected candidate slots refer to the slots determined from the resource selection window, which are defined to provide candidate resources and also referred to as candidate slots; and the sensing occasion refers to a slot where the terminal device monitors the sidelink control information. In addition, the Chinese and English names of the selected candidate slots and the sensing occasion are not limited herein, which may be replaced by other names in some possible cases.

In exemplary embodiments, in the case that the first parameter is configured, Q is equal to one of the following values regardless of whether the first slot is a sensing occasion determined based on the first parameter: 1, 2, ┌Tscal/Prx┐, and ┌Tscal/Prx┐+1.

In other exemplary embodiments, in the case that the first parameter is configured and the first slot is a sensing occasion determined based on the first parameter, Q is equal to 1 or 2 or ┌Tscal/Prx┐ or ┌Tscal/Prx┐+1; or in the case that the first parameter is configured and the first slot is not a sensing occasion determined based on the first parameter, Q is equal to 1 or ┌Tscal/Prx┐. Exemplarily, with reference to FIG. 5, the slot t_{y0-2*P2lg} and the slot t_{y0-2*P1lg} are sensing occasions determined based on the first parameter, as such the parameter additionalPeriodicSensingOccasion, and in determining the Q slots corresponding to the slot t_{y0-2*P2lg} or the slot t_{y0-2*P1lg}, Q is equal to 1 or 2 or ┌Tscal/Prx┐ or ┌Tscal/Prx┐+1. For another example, the slot t_{y0-P2lg} and the slot t_{y0-P1lg} are not sensing occasions determined based on the first parameter, such as the parameter additionalPeriodicSensingOccasion, and in determining the Q slots corresponding to the slot t_{y0-P2lg} or the slot t_{y0-P1lg}, Q is equal to 1 or ┌Tscal/Prx┐.

In addition, whether the first slot is a sensing occasion determined based on the first parameter refers to whether the first slot is an additional periodic sensing occasion determined based on the first parameter.

According to the technical solutions in the embodiments of the present disclosure, for the resource exclusion process in the partial sensing mechanism, in the case that the first parameter is configured, Q may be equal to 2 or ┌Tscal/Prx┐+1 in addition to 1 or ┌Tscal/Prx┐, thereby addressing the problem that resource exclusion fails to be correctly performed based on an additional sensing occasion even in the case that the additional sensing occasion is configured, and enabling the terminal device to correctly perform resource exclusion, such that the communication reliability is improved.

Referring to FIG. 8, a flowchart of a method for resource exclusion according to some embodiments of the present disclosure is shown. The method is applicable to the network architecture as shown in FIG. 1. For example, the method may be performed by the terminal device. The method includes at least one of the following steps (810-820).

In step 810, Q slots corresponding to a first slot where sidelink control information is monitored are determined based on the first slot, wherein in the case that a first parameter is configured, Q is equal to 2 or ┌Tscal/Prx┐+1, wherein the first parameter is defined to indicate an additional periodic sensing occasion, Prx represents a resource reservation period carried in the sidelink control information, and Tscal is determined based on a resource selection window or selected candidate slots.

In the embodiments, in the case that the first parameter is configured, Q may be equal to 2 or ┌Tscal/Prx┐+1.

It is also assumed that m represents the first slot, Prxlg represents a number of logical slots converted from Prx, and that n1 represents a reference slot. In some embodiments, with the first parameter configured, in the case that m+2*Prxlg is greater than or equal to n1 and Prx is less than Tscal, Q=┌Tscal/Prx┐+1. Exemplarily, in the case that m+2*Prxlg≥n1 and Prx<Tscal, Q=┌Tscal/Prx┐+1. That is, in the case that n1−m≤2*Prxlg and Prx<Tscal, Q=┌Tscal/Prx┐+1.

In some embodiments, with the first parameter configured, in the case that the condition that m+2*Prxlg is greater than or equal to n1 and Prx is less than Tscal does not hold, Q=2.

In some embodiments, without configuring the first parameter, in the case that m+Prxlg is greater than or equal to n1 and Prx is less than Tscal, Q=┌Tscal/Prx┐; or otherwise, Q=1. Exemplarily, in the case that m+Prxlg≥n1 and Prx<Tscal, Q=┌Tscal/Prx┐; or otherwise, Q=1. That is, in the case that n1−m≤Prxlg and Prx<Tscal, Q=┌Tscal/Prx┐; or otherwise, Q=1.

In step 820, in the case that resources determined based on the first slot and the Q slots overlap with a first resource or a periodic resource corresponding to the first resource, the first resource is excluded.

Step 820 is similar to step 620 in the embodiments of FIG. 6 as described above. For details about step 820, reference is made to the description in the above embodiments, which are not described herein any further.

In addition, for other details that are not specified in the embodiments, reference is made to the description in the embodiments of FIG. 6 as described above. For example, for descriptions of the first parameter, the first slot, the resource selection window, the selected candidate slots, and the like involved in the embodiments, reference is made to the description in the embodiments of FIG. 6 as described above, which are not described herein any further.

According to the technical solutions in the embodiments of the present disclosure, for the resource exclusion process in the partial sensing mechanism, in the case that the first parameter is configured, Q may be equal to 2 or ┌Tscal/Prx┐+1, addressing the problem that resource exclusion fails to be correctly performed based on an additional sensing occasion even in the case that the additional sensing occasion is configured, enabling the terminal device to correctly perform resource exclusion, such that the communication reliability is improved.

The technical solutions of the present disclosure are described hereinafter with reference to some exemplary embodiments.

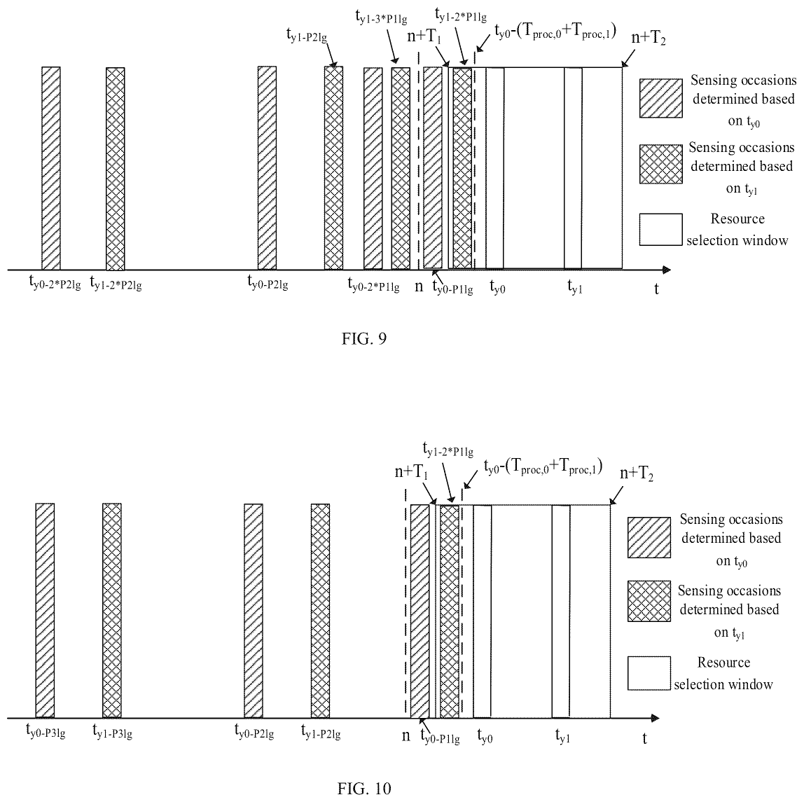

In some embodiments, as shown in FIG. 9, it is assumed that the allowed resource reservation periods in the resource pool arc P1, P2, and P3, periodic SensingOccasionReservePeriodList is configured in the resource pool to include P1 and P2, and that the parameter additionalPeriodicSensingOccasion is configured in the resource pool configuration. (t₁, t₂, t₃, t₄, . . . ) denote slots within the resource pool.

The slot n is the slot where the higher layer triggers the physical layer to report the candidate resource set, and the resource selection window is from n+T₁ to n+T₂, wherein for details about T₁ and T₂, reference is made exemplarily to the above description. The terminal device determines two candidate slots in the resource selection window, including t_{y0} and t_{y1}. The sensing occasions determined by the terminal device based on t_{y0} and t_{y1} are shown in FIG. 9, and for specific details of the determination, reference is made to the above description. The terminal device should perform sensing in the sensing occasions determined based on t_{y0} and t_{y1}. In addition, the terminal device further performs contiguous sensing in ┌n+T_{A}, n+T_{B}┐, wherein n+T_{A} is equal to t_{y0-31}, and n+T_{B} is equal to t_{y0}−(T_{proc,0}+T_{proc,1}). In some embodiments, the terminal device performs sensing in a slot within the resource pool in ┌n+T_{A}, n+T_{B}┐.

The terminal device initializes the candidate resource set into all available resources in t_{y0} and t_{y1}, and performs exclusion on the resources in the candidate resource set based on the sensing occasions determined from t_{y0} and t_{y1} and the first sidelink control information monitored in ┌n+T_{A}, n+T_{B}┐. Any of the resources in the candidate resource set is denoted as R(x, y), wherein x represents a frequency domain location of the resource and y represents a time domain location of the resource. Assuming that the first time unit is t_{y0}−(T_{proc,0}+T_{proc,1}), and that t_{y0}−(T_{proc,0}+T_{proc,1}) is within the resource pool, then tₙ₁ is equal to t_{y0}−(T_{proc,0}+T_{proc,1}). Tscal is equal to the ending slot of the resource selection window n+T₂ minus t_{y0}−(T_{proc,0}+T_{proc,1}).

It is assumed that the terminal device receives first sidelink control information 1 at a slot t_{y1-2*P2lg}, and measures an SL-RSRP of a PSCCH where the first sidelink control information 1 is or a PSSCH scheduled by the PSCCH. Assuming that the resource reservation period carried in the first sidelink control information 1 is P2, then the terminal device determines Q corresponding slots based on the slot t_{y1-2*P2lg} and P2. Exemplarily, as y1−2*P2lg+P2lg is less than n1, y1−2*P21g+2*P21g is greater than n1, and P2 is greater than Tscal, Q is equal to 2. The terminal device assumes that the first sidelink control information 1 with the same content is received at both the slot t_{y1-2*P2lg+P2lg} and the slot t_{y1-2*P2lg+2*P2lg}, i.e., the slots t_{y1-P2lg} and t_{y1}. In the case that the resources indicated by the “time resource assignment” and “frequency resource assignment” fields in the first sidelink control information 1 received at the slot t_{y1-2*P2lg} and the first sidelink control information assumed to be received at t_{y1-P2lg} and t_{y1} overlap with R(x, y) or R(x, y+j*Ptxlg) and the measured SL-RSRP is greater than an RSRP threshold, the resource R(x, y) is excluded from the candidate resource set, wherein j=0, 1, . . . , Cresel-1. Cresel is associated with a random count value generated by the terminal device. Ptxlg represents the number of the logical slots converted from Ptx. Ptx is the resource reservation period of the terminal device.

It is assumed that the terminal device receives first sidelink control information 2 at a slot t_{y0-2*P1lg}, and measures an SL-RSRP of a PSCCH where the first sidelink control information 2 is or a PSSCH scheduled by the PSCCH. Assuming that the resource reservation period carried in the first sidelink control information 2 is P1, then the terminal device determines Q corresponding slots based on the slot t_{y0-2*P2lg} and P1. Exemplarily, as y0−2*P1lg+P1lg is less than n1, y0−2*P1lg+2*P1lg is greater than n1, and P1<Tscal, Q=┌Tscal/Prx┐+1. Assuming that ┌Tscal/P1┐ is equal to 2, then Q is equal to 3. The terminal device assumes that the first sidelink control information 2 with the same content is received at slots t_{y0-2*P1lg+P1lg}t_{y0-2*P1lg+2*P1lg}, and t_{y0-2*P1lg+3*P1lg}, i.e., t_{y0-P1lg}, t_{y0}, and t_{y0+P1lg}. In the case that the resources indicated by the “time resource assignment” and “frequency resource assignment” fields in the first sidelink control information 2 received at the slot t_{y0-2*P1lg} and the first sidelink control information assumed to be received at t_{y0-P1lg}, t_{y0}, and t_{y0+P1lg} overlap with R(x, y) or R(x,y+j*Ptxlg) and the measured SL-RSRP is greater than the RSRP threshold, the resource R(x, y) is excluded from the candidate resource set, wherein j=0, 1, . . . , Cresel-1. Cresel is associated with a random count value generated by the terminal device. Ptxlg represents the number of the logical slots converted from Ptx. Ptx is the resource reservation period of the terminal device.

In other embodiments, as shown in FIG. 10, it is assumed that the allowed resource reservation periods in the resource pool arc P1, P2, and P3, periodicSensingOccasionReservePeriodList is not configured in the resource pool, and that the parameter additionalPeriodicSensingOccasion is not configured. (t₁, t₂, t₃, t₄, . . . ) denote slots within the resource pool.

The slot n is a slot where the higher layer triggers the physical layer to report the candidate resource set, and the resource selection window is from n+T₁ to n+T₂, wherein for details about T₁ and T₂, reference is made to the above description. The terminal device determines two candidate slots in the resource selection window, including t_{y0} and t_{y1}. The sensing occasions determined by the terminal device based on t_{y0} and t_{y1} are shown in FIG. 10, and for specific details of the determination, reference is made to the background part. The terminal device should perform sensing in the sensing occasions determined based on t_{y0} and t_{y1}. In addition, the terminal device further performs contiguous sensing in [n+T_{A}, n+T_{B}], wherein n+T_{A} is equal to t_{y0-31}, and n+T_{B} is equal to t_{y0}−(T_{proc,0}+T_{proc,1}). In some embodiments, the terminal device performs sensing in a slot within the resource pool in [n+T_{A}, n+T_{B}].

The terminal device initializes the candidate resource set into all available resources in t_{y0} and t_{y1}, and performs exclusion on the resources in the candidate resource set based on the sensing occasions determined from t_{y0} and t_{y1} and the first sidelink control information monitored in [n+T_{A}, n+T_{B}]. Any of the resources in the candidate resource set is denoted as R(x, y), wherein x represents a frequency domain location of the resource and y represents a time domain location of the resource. Assuming that the first time unit is t_{y0}−(T_{proc,0}+T_{proc,1}), and that t_{y0}−(T_{proc,0}+T_{proc,1}) is within the resource pool, then tₙ₁ is equal to t_{y0}−(T_{proc,0}+T_{proc,1}). Tscal is equal to the ending slot of the resource selection window n+T₂ minus t_{y0}−(T_{proc,0}+T_{proc,1}).

It is assumed that the terminal device receives first sidelink control information 1 at a slot t_{y1-2*P1lg}, and measures a SL-RSRP of a PSCCH where the first sidelink control information 1 is or a PSSCH scheduled by the PSCCH. Assuming that the resource reservation period carried in the first sidelink control information 1 is P1, then the terminal device determines Q corresponding slots based on the slot t_{y1-2*P1lg} and P1. Exemplarily, as y1−2*P1lg+P1lg is greater than n1 and P1 is less than Tscal, Q is equal to ┌Tscal/Prx┐. Assuming that ┌Tscal/P1┐=2, then Q is equal to 2. The terminal device assumes that the first sidelink control information 1 with the same content is received at both the slot t_{y1-2*P1lg+P1lg} and the slot t_{y1-2*P1lg+2*P1lg}, i.e., the slots t_{y1-P1lg} and t_{y1}. In the case that the resources indicated by the “time resource assignment” and “frequency resource assignment” fields in the first sidelink control information 1 received at the slot t_{y1-2*P1lg} and the first sidelink control information assumed to be received at t_{y1-P1lg} and t_{y1} overlap with R(x, y) or R(x, y+j*Ptxlg) and the measured SL-RSRP is greater than a RSRP threshold, the resource R(x, y) is excluded from the candidate resource set, wherein j=0, 1, . . . , Cresel-1. Cresel is associated with a random count value generated by the terminal device. Ptxlg represents the number of the logical slots converted from Ptx. Ptx is the resource reservation period of the terminal device.

The following is an apparatus embodiment of the present disclosure that may be configured to implement the method embodiments of the present disclosure. For details that are not disclosed in the apparatus embodiment of the present disclosure, reference is made to the method embodiments of the present disclosure.

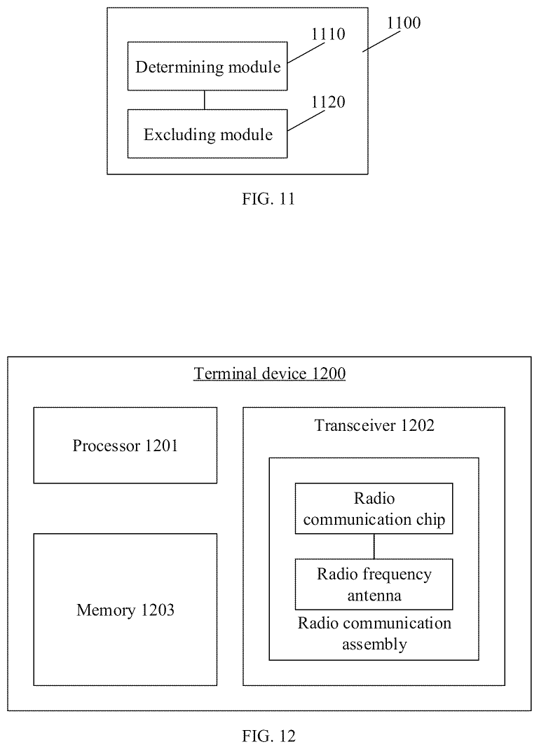

Referring to FIG. 11, a block diagram of an apparatus for resource exclusion according to some embodiments of the present disclosure is shown. The apparatus has the function of implementing the above method embodiments, and the function may be achieved by hardware or by hardware executing corresponding software. The apparatus may be, or provided in the terminal device described above. As shown in FIG. 11, the apparatus 1100 may include: a determining module 1110 and an excluding module 1120.

The determining module 1110 is configured to determine, based on a first slot where sidelink control information is monitored, Q slots corresponding to the first slot, where in the case that a first parameter is configured, Q is equal to 1 or 2 or ┌Tscal/Prx┐ or ┌Tscal/Prx┐+1, wherein the first parameter is defined to indicate an additional periodic sensing occasion, Prx represents a resource reservation period carried in the sidelink control information, and Tscal is determined based on a resource selection window or selected candidate slots.

The excluding module 1120 is configured to exclude a first resource in the case that resources determined based on the first slot and the Q slots overlap with the first resource or a periodic resource corresponding to the first resource.

In some embodiments, in the case that m+Prxlg is less than n1, m+2*Prxlg is greater than or equal to n1, and Prx is less than Tscal, Q=┌Tscal/Prx┐+1, wherein m represents the first slot, Prxlg represents a number of logical slots converted from Prx, and n1 represents a reference slot.

In some embodiments, in the case that m+Prxlg is less than n1, m+2*Prxlg is greater than or equal to n1, and Prx is greater than or equal to Tscal, Q=2, wherein m represents the first slot, Prxlg represents the number of the logical slots converted from Prx, and n1 represents the reference slot.

In some embodiments, in the case that m+Prxlg is greater than or equal to n1 and Prx is less than Tscal, Q=┌Tscal/Prx┐, wherein m represents the first slot, Prxlg represents the number of the logical slots converted from Prx, and n1 represents the reference slot.

In some embodiments, in the case that m+Prxlg is greater than or equal to n1 and Prx is greater than or equal to Tscal, Q=1, wherein m represents the first slot, Prxlg represents the number of the logical slots converted from Prx, and n1 represents the reference slot.

In some embodiments, in the case that m+Prxlg is less than n1 and m+2*Prxlg is less than n1, Q=1 or 2, wherein m represents the first slot, Prxlg represents the number of the logical slots converted from Prx, and n1 represents the reference slot.

In some embodiments, in the case that m+2*Prxlg is greater than or equal to n1 and Prx is less than Tscal, Q=┌Tscal/Prx┐+1; or otherwise, Q=2, wherein m represents the first slot, Prxlg represents the number of the logical slots converted from Prx, and n1 represents the reference slot. In some embodiments, in the case that the first parameter is not configured:

in the case that m+Prxlg is greater than or equal to n1 and Prx is less than Tscal, Q=┌Tscal/Prx┐; or otherwise, Q=1,
wherein m represents the first slot, Prxlg represents the number of the logical slots converted from Prx, and n1 represents the reference slot.

In some embodiments, the reference slot is determined by a first time unit, the first time unit is within a first time domain interval, or the first time unit is a slot where a higher layer triggers a physical layer to report a resource set, wherein a starting position of the first time domain interval includes a last sensing occasion in a time domain determined by a terminal device, and an ending position of the first time domain interval includes a first selected candidate slot in the time domain determined by the terminal device.

In some embodiments, in the case that the first time unit is within a resource pool, the reference slot is the first time unit; or in the case that the first time unit is not within the resource pool, the reference slot is a first slot within the resource pool after the first time unit.

In some embodiments, the resource pool is a resource pool of the terminal device, or a transmission resource pool of the terminal device, or a resource pool used by the terminal device.

In some embodiments, in the case that the first time unit is within the first time domain interval, the first time unit is: the last sensing occasion in the time domain determined by the terminal device, or the last sensing occasion in the time domain determined by the terminal device plus a first offset, or the first selected candidate slot in the time domain determined by the terminal device, or the first selected candidate slot in the time domain determined by the terminal device minus a second offset.

In some embodiments, the first offset is configured by a network, or preconfigured, or dependent on implementation of the terminal device, or a predefined value specified in a standard.

In some embodiments, the second offset is configured by the network, or preconfigured, or dependent on implementation of the terminal device, or a predefined value specified in a standard.

In some embodiments, the first resource is any of resources in a candidate resource set.

The excluding module 1120 is configured to exclude the first resource from the candidate resource set.

The candidate resource set is an initialized resource set and includes all candidate resources in selected candidate slots determined by the terminal device; or the candidate resource set is a resource set formed by remaining resources in the initialized resource set after resource exclusion.

In some embodiments, the selected candidate slots are part of slots determined within the resource selection window by the terminal device.

In some embodiments, in the case that the first parameter is configured and the first slot is a sensing occasion determined based on the first parameter, Q is equal to 1 or 2 or ┌Tscal/Prx┐ or ┌Tscal/Prx┐+1; or in the case that the first parameter is configured and the first slot is not a sensing occasion determined based on the first parameter, Q is equal to 1 or ┌Tscal/Prx┐.

According to the technical solutions in the embodiments of the present disclosure, for the resource exclusion process in the partial sensing mechanism, in the case that the first parameter is configured, Q may be equal to 2 or ┌Tscal/Prx┐+1 in addition to 1 or ┌Tscal/Prx┐, addressing the problem that resource exclusion fails to be correctly performed based on an additional sensing occasion even in the case that the additional sensing occasion is configured, enabling the terminal device to correctly perform resource exclusion, such that the communication reliability is improved.

It should be noted that, in the case that the apparatus according to the above embodiments implements the functions thereof, the division of the functional modules is merely exemplary. In practical application, the above functions may be assigned to different functional modules according to actual needs, i.e., the device may be divided into different functional modules in terms of internal structure, so as to implement all or a part of the above functions.

With regard to the apparatus in the above embodiments, the specific manner in which each module performs the operation has been described in detail in the embodiments related to the method and will not be described in detail herein. For details that are not specified in the apparatus embodiment, reference is made to the above method embodiments.

Referring to FIG. 12, a schematic structural diagram of a terminal device according to some embodiments of the present disclosure is shown. The terminal device 1200 may include: a processor 1201, a transceiver 1202, and a memory 1203.

The processor 1201 includes one or more processing cores, and the processor 1201 executes various functional applications and information processing by running software programs and modules.

The transceiver 1202 may include a receiver and a transmitter, which may be implemented, for example, as the same radio communication assembly that may include a radio communication chip and a radio frequency antenna.

The memory 1203 may be coupled to the processor 1201 and the transceiver 1202.

The memory 1203 may be configured to store a computer program runnable by the processor, and the processor 1201 is configured to run the computer program to perform the steps in the above method embodiments.

In exemplary embodiments, the processor 1201 is configured to determine, based on a first slot where sidelink control information is monitored, Q slots corresponding to the first slot, wherein in the case that a first parameter is configured, Q is equal to 1 or 2 or ┌Tscal/Prx┐ or ┌Tscal/Prx┐+1, wherein the first parameter is defined to indicate an additional periodic sensing occasion, Prx represents a resource reservation period carried in the sidelink control information, and Tscal is determined based on a resource selection window or selected candidate slots.

The processor 1201 is further configured to exclude a first resource in the case that resources determined based on the first slot and the Q slots overlap with the first resource or a periodic resource corresponding to the first resource.

For details that are not specified in the embodiments, reference is made to the foregoing embodiments, which are not described herein any further.

In addition, the memory may be implemented by any type or combination of volatile or non-volatile storage devices, including, but not limited to: magnetic or optical discs, electrically erasable programmable read-only memories, static random-access memories, read-only memories, magnetic memories, flash memories, and programmable read-only memories.

Some embodiments of the present disclosure further provide a storage medium computer-readable storage medium storing a computer program therein. The computer program, when run by a processor, causes the processor to perform the method for resource exclusion described above. In some embodiments, the computer-readable storage medium may include: a read-only memory (ROM), a random-access memory (RAM), a solid state drive (SSD), an optical disc, and the like. The RAM may include a resistance random-access memory (ReRAM) and a dynamic random-access memory (DRAM).

Some embodiments of the present disclosure further provide a chip. The chip includes a programmable logic circuit and/or program instructions, wherein the chip, when running, is configured to perform the method for resource exclusion described above.

Some embodiments of the present disclosure further provide a computer program product or computer program. The computer program product or computer program includes computer instructions stored in a computer-readable storage medium, wherein the computer instructions, when read from the computer-readable storage medium and executed by a processor, cause the processor to perform the method for resource exclusion described above.

It should be understood that some equations or inequations involved in the embodiments of the present disclosure may be simply transformed by mathematical operations. For example, m+Prxlg<n1 is equivalent to n1−m>Prxlg, Prxlg<n1−m, m<n1−Prxlg, n1−Prxlg>m, m+Prxlg−n1<0, n1−m−Prxlg>0, and the like, which are not exemplified exhaustively but all within the protection scope of the present disclosure.

The “indication” as mentioned in the embodiments of the present disclosure may be a direct indication, an indirect indication, or an indication of an association. For example, A indicates B, which can mean that A indicates B directly, e.g., B may be acquired by A; or that A indicates B indirectly, e.g., A indicates C by which B may be acquired; or that an association is present between A and B.

In the description of the embodiments of the present disclosure, the term “corresponding” may refer to a direct correspondence or an indirect correspondence that is present between two items, may refer to an association that is present between two items, or may refer to another relationship such as indicating and being indicated, configuring and being configured.

In some embodiments of the present disclosure, “predefined” is implemented by pre-storing corresponding codes, tables, or other means that may be defined to indicate related information in devices (including, for example, terminal devices and network devices), and the present disclosure does not limit the specific implementation thereof. For example, “predefined” refers to “defined” in a protocol.

In some embodiments of the present disclosure, the “protocol” refers to a standard protocol in the communications field including, for example, the LTE protocol, the NR protocol, and related protocols applied in future communication systems, which is not limited in the present disclosure.

The mentioned term “a plurality of” herein means two or more. The term “and/or” describes the association relationship of the associated objects, and indicates that three relationships may be present. For example, A and/or B may indicate that: only A is present, both A and B are present, and only B is present. The symbol “/” generally indicates an “or” relationship between the associated objects.

In addition, serial numbers of the steps described herein only show an exemplary possible execution sequence among the steps, and in some other embodiments, the steps may also be executed out of the numbering sequence, for example, two steps with different serial numbers are executed simultaneously, or two steps with different serial numbers are executed in a reverse order to the illustrated sequence, which is not limited in the present disclosure.

Those skilled in the art should be appreciated that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium, wherein the communication medium includes any medium that facilitates transfer of a computer program from one place to another. The storage medium is any available medium that is accessible by a general purpose or special purpose computer.

Described above are merely exemplary embodiments of the present disclosure and are not intended to limit the present disclosure. Any modifications, equivalent substitutions, improvements, and the like, made within the spirit and principle of the present disclosure should fall within the protection scope of the present disclosure.

1. A method for resource exclusion, applicable to a terminal device, the method comprising:
determining, based on a first slot where sidelink control information is monitored, Q slots corresponding to the first slot, wherein in a case that a first parameter is configured, Q is equal to 1 or 2 or ┌Tscal/Prx┐ or ┌Tscal/Prx┐+1, wherein the first parameter is defined to indicate an additional periodic sensing occasion, Prx represents a resource reservation period carried in the sidelink control information, and Tscal is determined based on a resource selection window or selected candidate slots; and
excluding a first resource in a case that resources determined based on the first slot and the Q slots overlap with the first resource or a periodic resource corresponding to the first resource.

2. The method for resource exclusion according to claim 1, wherein in a case that m+Prxlg is greater than or equal to n1 and Prx is less than Tscal, Q=┌Tscal/Prx┐, wherein m represents the first slot, Prxlg represents a number of logical slots converted from Prx, and n1 represents a reference slot.

3. The method for resource exclusion according to claim 1, wherein in a case that m+Prxlg is greater than or equal to n1 and Prx is greater than or equal to Tscal, Q=1, wherein m represents the first slot, Prxlg represents a number of logical slots converted from Prx, and n1 represents a reference slot.

4. The method for resource exclusion according to claim 1, wherein in a case that m+Prxlg is less than n1 and m+2*Prxlg is less than n1, Q=1 or 2, wherein m represents the first slot, Prxlg represents a number of logical slots converted from Prx, and n1 represents a reference slot.

5. The method for resource exclusion according to claim 1, wherein in a case that the first parameter is not configured:
in a case that m+Prxlg is greater than or equal to n1 and Prx is less than Tscal, Q=┌Tscal/Prx┐; or otherwise, Q=1;
wherein m represents the first slot, Prxlg represents a number of logical slots converted from Prx, and n1 represents a reference slot.

6. The method for resource exclusion according to claim 2, wherein the reference slot is determined by a first time unit, the first time unit is within a first time domain interval, or the first time unit is a slot where a higher layer triggers a physical layer to report a resource set, wherein a starting position of the first time domain interval comprises a last sensing occasion in a time domain determined by the terminal device, and an ending position of the first time domain interval comprises a first selected candidate slot in the time domain determined by the terminal device.

7. The method for resource exclusion according to claim 6, wherein:
in a case that the first time unit is within a resource pool, the reference slot is the first time unit; or
in a case that the first time unit is not within the resource pool, the reference slot is a first slot within the resource pool after the first time unit.

8. The method for resource exclusion according to claim 7, wherein the resource pool is a resource pool of the terminal device, or a transmission resource pool of the terminal device, or a resource pool used by the terminal device.

9. The method for resource exclusion according to claim 6, wherein in a case that the first time unit is within the first time domain interval, the first time unit is: the last sensing occasion in the time domain determined by the terminal device, or the last sensing occasion in the time domain determined by the terminal device plus a first offset, or the first selected candidate slot in the time domain determined by the terminal device, or the first selected candidate slot in the time domain determined by the terminal device minus a second offset.

10. The method for resource exclusion according to claim 9, wherein the second offset is configured by a network, or preconfigured, or dependent on implementation of the terminal device, or a predefined value specified in a standard.

11. The method for resource exclusion according to claim 1, wherein:
the first resource is any of resources in a candidate resource set; and
excluding the first resource comprises:
excluding the first resource from the candidate resource set;
wherein the candidate resource set is an initialized resource set and comprises all candidate resources in selected candidate slots determined by the terminal device; or the candidate resource set is a resource set formed by remaining resources in the initialized resource set after resource exclusion.

12. The method for resource exclusion according to claim 1, wherein the selected candidate slots are part of slots determined within the resource selection window by the terminal device.

13. A terminal device, comprising: a processor and a memory storing a computer program therein, wherein the processor, when running the computer program, is caused to perform:
determining, based on a first slot where sidelink control information is monitored, Q slots corresponding to the first slot, wherein in a case that a first parameter is configured, Q is equal to 1 or 2 or ┌Tscal/Prx┐ or ┌Tscal/Prx┐+1, wherein the first parameter is defined to indicate an additional periodic sensing occasion, Prx represents a resource reservation period carried in the sidelink control information, and Tscal is determined based on a resource selection window or selected candidate slots; and
excluding a first resource in a case that resources determined based on the first slot and the Q slots overlap with the first resource or a periodic resource corresponding to the first resource.

14. The terminal device according to claim 13, wherein in a case that m+Prxlg is greater than or equal to n1 and Prx is less than Tscal, Q=┌Tscal/Prx┐, wherein m represents the first slot, Prxlg represents a number of logical slots converted from Prx, and n1 represents a reference slot.

15. The terminal device according to claim 13, wherein in a case that m+Prxlg is greater than or equal to n1 and Prx is greater than or equal to Tscal, Q=1, wherein m represents the first slot, Prxlg represents a number of logical slots converted from Prx, and n1 represents a reference slot.

16. The terminal device according to claim 13, wherein in a case that m+Prxlg is less than n1 and m+2*Prxlg is less than n1, Q=1 or 2, wherein m represents the first slot, Prxlg represents a number of logical slots converted from Prx, and n1 represents a reference slot.

17. The terminal device according to claim 13, wherein in a case that the first parameter is not configured:
in a case that m+Prxlg is greater than or equal to n1 and Prx is less than Tscal, Q=┌Tscal/Prx┐; or otherwise, Q=1;
wherein m represents the first slot, Prxlg represents a number of logical slots converted from Prx, and n1 represents a reference slot.

18. The terminal device according to claim 14, wherein the reference slot is determined by a first time unit, the first time unit is within a first time domain interval, or the first time unit is a slot where a higher layer triggers a physical layer to report a resource set, wherein a starting position of the first time domain interval comprises a last sensing occasion in a time domain determined by the terminal device, and an ending position of the first time domain interval comprises a first selected candidate slot in the time domain determined by the terminal device.

19. The terminal device according to claim 18, wherein:
in a case that the first time unit is within a resource pool, the reference slot is the first time unit; or
in a case that the first time unit is not within the resource pool, the reference slot is a first slot within the resource pool after the first time unit.

20. A non-transitory computer-readable storage medium storing a computer program, which when executed by a processor, causes the processor to:
determine, based on a first slot where sidelink control information is monitored, Q slots corresponding to the first slot, wherein in a case that a first parameter is configured, Q is equal to 1 or 2 or ┌Tscal/Prx┐ or ┌Tscal/Prx┐+1, wherein the first parameter is defined to indicate an additional periodic sensing occasion, Prx represents a resource reservation period carried in the sidelink control information, and Tscal is determined based on a resource selection window or selected candidate slots; and
exclude a first resource in a case that resources determined based on the first slot and the Q slots overlap with the first resource or a periodic resource corresponding to the first resource.
